(19) United States
(12) Patent Application Publication
(10) Pub. No.: US 2026/0026441 A1
(43) Pub. Date: Jan. 29, 2026

(54) PISTON PRESS

(71) Applicant: Usines CLAAS France S.A.S, Rémy/Woippy (FR)

(72) Inventor: Cyrille Arnould, Montoy Flonville (FR)

(73) Assignee: Usines CLAAS France S.A.S, Rémy/Woippy (FR)

(21) Appl. No.: 19/281,941

(22) Filed: Jul. 28, 2025

(30) Foreign Application Priority Data
Jul. 26, 2024 (DE) 10 2024 121 329.9

(51) Int. Cl. A01F 15/10

(52) U.S. Cl. CPC A01F 15/101; A01F 2015/102

(57) ABSTRACT

A piston press. The piston press includes a press piston arranged or positioned movably between end positions in a pressing channel, a feed channel, a feed rake gearbox, and a feed rake. The feed rake may be moved driven in the feed channel via a first gearbox output of the feed rake gearbox in order to perform a gathering stroke movement in a first operating mode, which compresses the harvested material in the feed channel, and a filling stroke movement in a second operating mode, which may displace the harvested material from the feed channel into the pressing channel. The feed rake gearbox has a second gearbox output and may be switched to drive only the first gearbox output in one of the operating modes and to distribute drive power to both outputs in another of the operating modes.

### CROSS REFERENCE TO RELATED APPLICATION

This application claims priority under 35 U.S.C. § 119 to German Patent Application No. DE 10 2024 121 329.9 filed Jul. 26, 2024, the entire disclosure of which is hereby incorporated by reference herein.

### TECHNICAL FIELD

The present invention relates to a piston press.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 1 284 594 B1 disclose a piston press that has a feed channel to which collected harvested material is fed at one inlet end by a pickup. A feed rake engages through slots in a side wall of the feed channel into its interior in order to move the supplied harvested material in a gathering stroke movement to an outlet end and compress it there. When a sufficient quantity of harvested material has been collected at the outlet end of the feed channel, the feed rake performs a filling stroke movement through which the harvested material is moved into a pressing channel in which it is formed into a bale by a reciprocating ram. The bale is then tied and discharged after reaching a predetermined size.

The feed rake is mounted on a first end of a two-armed lever, the pivot point of which is moved on a circular path by a crank rotatably driven around a fixed axis. A second end of the lever is articulated via a control rod to a control arm, which in turn may pivot about a fixed axis and performs a period of its pivoting movement in the course of a gathering stroke movement. For a filling stroke movement, the control arm must be fixed to an end stop of its range of movement. So that this end stop is reached after each gathering stroke movement, a return spring is provided which acts on the control arm in the direction of the end stop.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a combination an example of a tractor and a baler in a schematic side view.

FIG. 2 illustrates an example of a feed rake and its gearbox in a feed channel of the baler.

FIG. 3 illustrates a detailed view of the feed rake gearbox.

FIG. 4 illustrates two gear wheels of the feed rake gear and a mechanism for their coupling and decoupling.

FIG. 5 illustrates a jaw of a jaw clutch that may be used in the feed rake gearbox.

### DETAILED DESCRIPTION

As discussed in the background, a return spring acts on the control arm in the direction of the end stop. Although this spring supports the movement of the control arm during part of the filling stroke movement, work must be performed on the spring during a preceding part of the movement. The need to tension the spring during each gathering stroke movement may cause the required drive torque to fluctuate greatly over the course of a gathering stroke movement and thereby strain a drive motor and the drive train running from there to the feed rake. A blockage of the spring may result in the end stop not being reached and a switchover to the filling stroke movement not being possible.

Thus, one object is to create a baler in which the one or more of the above-mentioned disadvantages are eliminated or at least partly alleviated.

This may be achieved with a piston press that comprises a press piston arranged or positioned movably in a pressing channel between end positions, a feed channel, a feed rake gearbox, and a feed rake which, driven via a first gearbox output of the feed rake gearbox, is movable or configured to move in the feed channel in order to execute a gathering stroke movement, which may compress harvested material in the feed channel in a first operating mode and a filling stroke movement which may displace the harvested material from the feed channel into the pressing channel in a second operating mode, the feed rake gearbox may have a second gearbox output and may be switched over in order to drive only the first output (such as the first gearbox output) in one of the operating modes (alternatively termed operating states) and to distribute drive power to both outputs in another of the operating modes. In this regard, the a feed rake gearbox may comprise a first gearbox output and a second gearbox output, with the feed rake being configured to move in the feed channel in order to operate in a plurality of operating modes including: in a first operating mode, execute a gathering stroke movement to compress harvested material in the feed channel; and in a second operating mode, a filling stroke movement which displaces the harvested material from the feed channel into the pressing channel. Further, the feed rake gearbox may be configured to control the second gearbox output in order to: drive only the first gearbox output in one of the plurality of operating modes; and to distribute drive power to both the first gearbox output and the second gearbox output in another of the plurality of operating modes.

In one or some embodiments, the one operating mode in which only the first gearbox output is driven is the first operating mode defined above, and the other operating mode in which the drive power is distributed is the second operating mode.

The second output, such as the second gearbox output, may be disengaged from a drive shaft of the feed rake gearbox in one operating mode and connected thereto in the second mode. The first gearbox output, on the other hand, may be permanently connected to the drive shaft.

In order to enable optional engagement and disengagement, the feed rake gearbox may comprise a pair of gears with a drive-side gear wheel and an output-side gear wheel, which may interact to drive the second gearbox output, wherein a toothing of the output-side gear wheel may have a gap in a part of its circumference, through which the teeth of the drive-side gear wheel pass in idling (e.g., without positive locking) in at least a first phase of the one operating mode, in which the output-side gear wheel is in a rest position.

In order to remove the output-side gear wheel from the rest position and to establish a frictional connection to the drive-side gear wheel, the drive-side gear wheel and the output-side gear wheel may each be rotationally coupled using respective movement stop, wherein the output-side gear wheel may be rotated by abutting the respective movement stops from the rest position into a position in which the teeth of the drive-side gear wheel engage with the teeth of the output-side gear wheel.

Similarly, to stop the output-side gear wheel in the rest position, the drive-side gear wheel and output-side gear wheel may each be rotationally coupled with respective stopper stop, wherein the output-side gear wheel may be stopped by abutting the respective stopper stops in a position in which the teeth of the drive-side gear wheel engage in the gap of the output-side gear wheel.

Each filling stroke movement may be followed by at least one gathering stroke movement, such as several gathering stroke movements. So that the movement stop of the drive-side gear wheel does not cause the output-side gear wheel to rotate with each rotation of the latter and thereby trigger the filling stroke movement, the movement stop of the drive-side gear wheel may be coupled to the drive-side gear wheel via a reduction gear.

In a compact design, the reduction gear may comprise a ring that is arranged or positioned eccentrically to an axis of the drive-side gear wheel, and an inner surface of the ring is in contact with an outer surface coupled to the drive-side gear wheel and centered around the axis. The inner and outer surfaces may be designed as friction surfaces. However, to prevent slippage, they may comprise a ring gear and a pinion engaging in the ring gear.

With the aid of the reduction gear, a fixed numerical ratio between collection and filling stroke movements may be realized. However, since the amount of harvested material grasped in each collecting stroke movement may be variable, the number of collecting stroke movements, each followed by a filling stroke movement, may also be variable as required. For this reason, a clutch may be provided by which the second gearbox output may be disengaged from the output-side gear wheel. In particular, the one operating mode (e.g., the first operating mode) may be divided into a first and a second phase, with the clutch decoupling the second gearbox output in the second phase. While the output-side gear wheel therefore remains in the rest position in the first phase, but the movement stop rotates with the drive-side gear wheel and triggers a rotation of the output-side gear wheel after a fixed number of rotations of the drive-side gear wheel, this rotation may be prevented from acting on the second gearbox output by opening the clutch. After each filling stroke movement, the drive-side gear wheel accordingly may first perform a fixed number of revolutions, such as exactly one, in which the output-side gear wheel remains in the rest position; subsequently, by opening the clutch, any number of rotations of the drive-side gear wheel may be added, during which the second gearbox output may remain motionless until a sufficient quantity of harvested material has accumulated in the feed channel for a filling stroke movement.

In one or some embodiments, the clutch may be designed as a jaw clutch (alternatively termed a claw clutch). The claws or jaws of a jaw clutch may generally only allow its closing in a limited number of orientations of the two clutch jaws in relation to each other. In one or some embodiments, the interlocking jaws of both jaws are shaped in such a way that they only allow closing in a single relative orientation; in this way, incorrect phasing of the two gearbox outputs in relation to each other, which may result in the feed rake executing a movement deviating from the filling stroke movement in the second operating mode, may be ruled out.

The feed rake may be driven by a lever which may bear the feed rake at a first end, and which may be coupled to the second gearbox output at a second end and to the first gearbox output at a central point between the first and second ends.

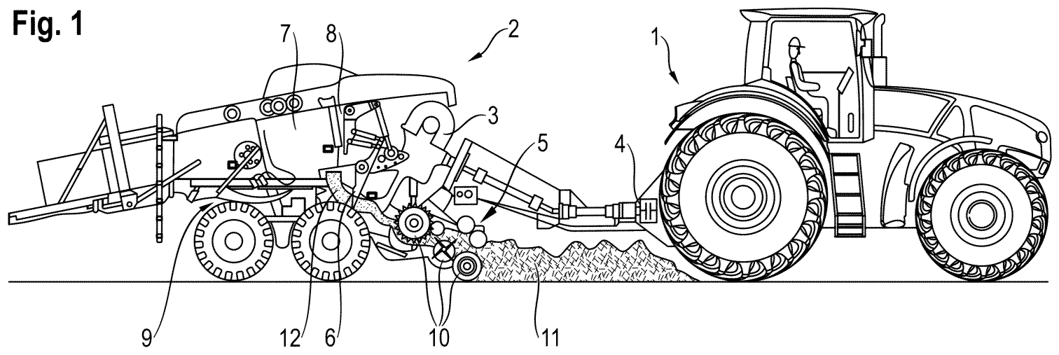

Referring to the figures, FIG. 1 shows a tractor 1 and a piston press 2 attached thereto. Examples of bale presses are disclosed in U.S. Pat. Nos. 8,555,780 and 10,314,238, both of which are incorporated by reference herein in their entirety. A transfer case 3 of the piston press may distribute drive torque supplied from the tractor 1 via a power take-off shaft 4 to a pickup 5, a feed rake 6, a press piston 8 moving in a pressing channel 7 sloping slightly to the rear in the longitudinal direction of the piston press 2 and a knotting mechanism 9. In a manner known per se, the pickup 5 may comprise a plurality of rotationally driven rollers 10 which may push the harvested material 11 together on an agricultural area, lift it and feed it into a feed channel 12.

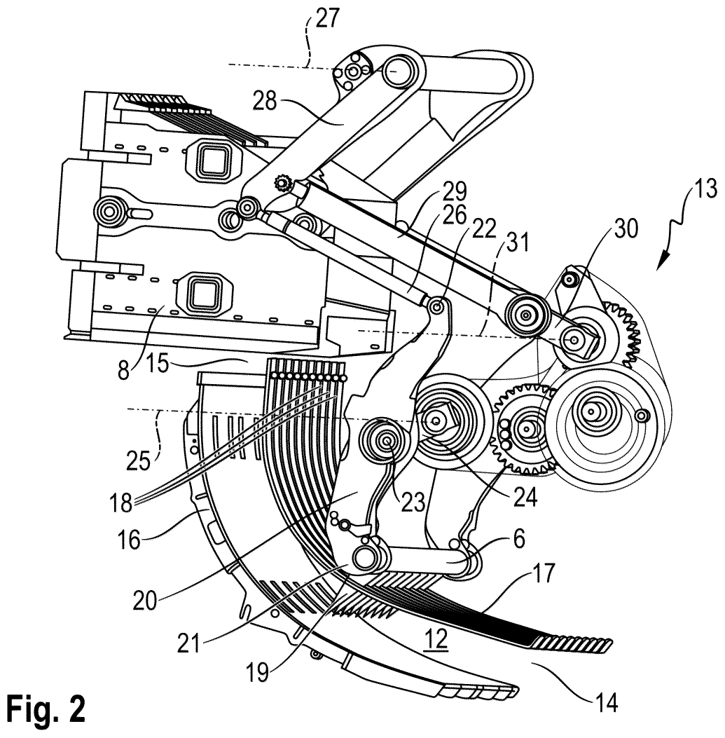

FIG. 2 illustrates in more detail the feed channel 12, the feed rake 6 and a feed rake gearbox 13, which may form part of the transfer gearbox 3. Curved walls 16, 17 may extend between an inlet end 14 facing the pickup 5 and an outlet end 15 of the feed channel 12 opening into the pressing channel 7. The wall 17 may have a large number of parallel slots through each of which tips 19 of the feed rake 6 may engage in the feed channel 12.

The feed rake 6 may be attached to a first end 21 of a lever 20. A pivot point 23 of the lever 20, located approximately centrally between the first end 21 and a second end 22, may be driven by a first gearbox output 24 (alternatively termed a first crank arm) of the feed rake gearbox 13 to move in a circular path about an axis 25. The second end 22 may be connected to a second gearbox output 30 (alternatively termed a second crank arm) of the feed rake gearbox 13 via a rod 26 articulated at both ends, an arm 28 pivotable about an axis 27 and another articulated rod 29.

When the second gearbox output 30 rotates about an axis 31, one drives a pendulum oscillation of the arm 28 about the axis 27 and thereby may force a movement of the second end 22 which, in conjunction with the orbital movement of the pivot point 23 about the axis 25, may guide the feed rake 6 in a filling stroke movement. If, on the other hand, the second gearbox output 30 is stationary in the position shown in FIG. 2, then the orbital movement of the pivot point 23 around the axis 25 may cause a gathering stroke movement of the feed rake 6.

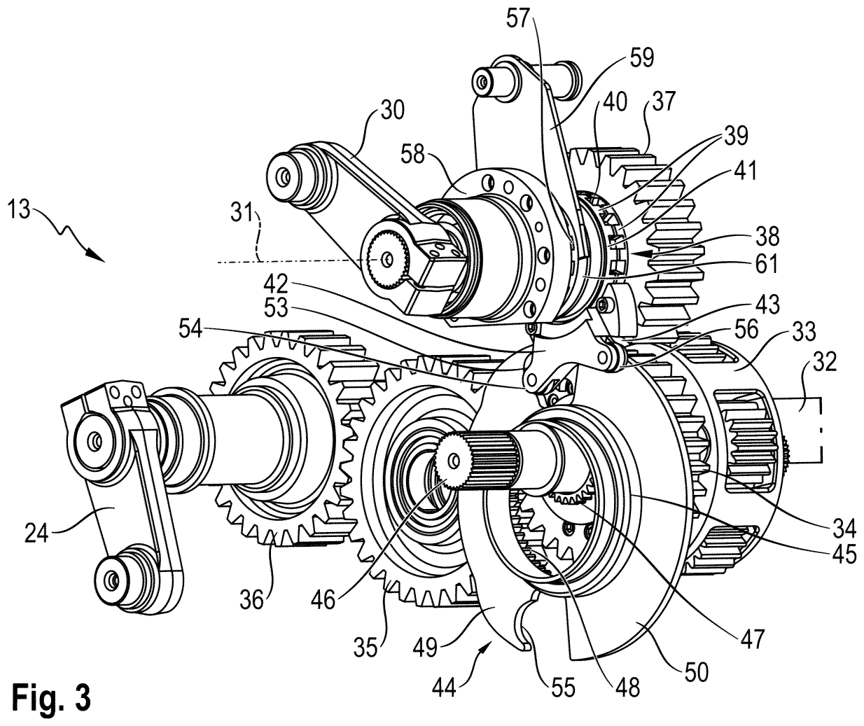

FIG. 3 illustrates the feed rake gearbox 13 from a similar perspective to FIG. 2. A drive shaft 32, coupled to the PTO shaft 4 via other components of the transfer case 3 (not shown), may drive a drive-side gear wheel 34 via a planetary gearbox 33. Its rotation may be transmitted via an intermediate gear wheel 35 to a first output-side gear wheel 36 and to the first gearbox output 24, rigidly connected thereto. The first gearbox output 24 may therefore form a first output, via which the feed rake gearbox 13 may perform work on the feed rake 6.

An output-side gear wheel 37 may be arranged or positioned adjacent to the drive-side gear wheel 34 and may be rotatable about the axis 31. A jaw clutch 38 may be arranged or positioned on the axis 31 in order to be able to selectively open and close a torque-transmitting connection to the second gearbox output 30. FIG. 3 illustrates the jaw clutch 38 in the open position with jaws 39 (or claws), axially spaced from each other, of its two jaws 40, 41.

A cam 42 and a component with a concave outer contour 43 may be non-rotatably connected to the output-side gear wheel 37. In the perspective in FIG. 3, they cover a gap in the toothing of the output-side gear wheel 37.

In FIG. 3, the drive-side gear wheel 34 is largely concealed behind a component 44. A central ring 45 of the component 44 eccentrically surrounds a stud axle 46 which may be connected for conjoint rotation to the drive-side gear wheel 34. Immediately adjacent to the drive-side gear wheel 34, a pinion 47 may be discerned in the opening of the ring 45, which may mesh with a ring gear 48 on the inner surface of the ring 45 and therefore may set the component 44 in rotation at an integer fraction, such as half, of the rotational speed of the drive-side gear wheel 34.

The ring 45 may bear two plates 49, 50, which may be axially offset from each other and each extend radially over approximately half of its circumference.

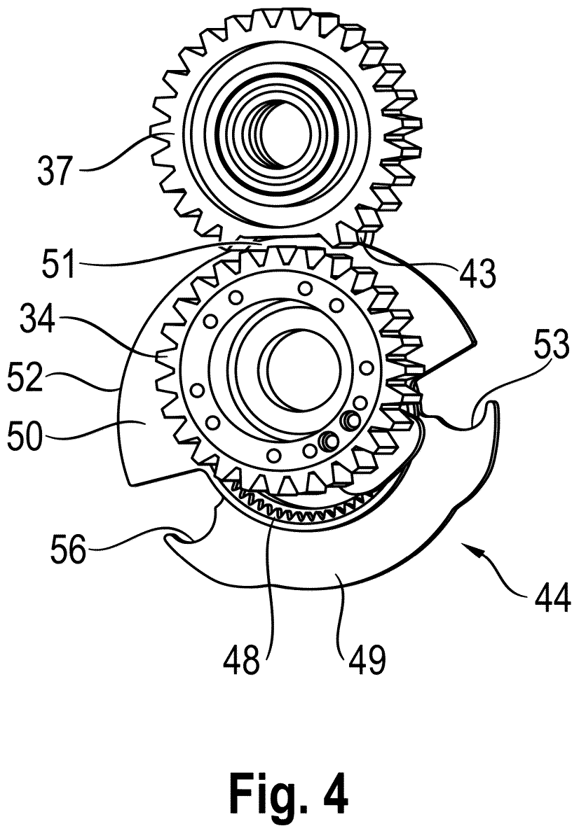

Their function may be understood from FIG. 4, which illustrates the drive-side gear wheel 34 and output-side gear wheel 37 and the component 44 from the opposite direction to FIG. 3, from the side of the drive shaft 32. In this case, the one gap in the toothing of the output-side gear wheel 37, labeled 51, may be seen, which may allow the drive-side gear wheel 34 to rotate freely without entraining the output-side gear wheel 37. Since the concave outer contour 43 (largely concealed by the output-side gear wheel 37 in FIG. 4) lies opposite an arcuate (or arc-shaped contour) edge 52 of the plate 50 at a small distance, the output-side gear wheel 37 may be prevented from any rotation that could bring its teeth into engagement with those of the drive-side gear wheel 34.

As mentioned, the component 44 may be rotatably driven by the drive-side gear wheel 34 via its ring gear 48. In the view depicted in FIG. 4, the direction of rotation of the component 44 is counterclockwise. A front edge of the plate 49 in the direction of rotation therefore may act as a movement stop 53 which, as shown in FIG. 3, abuts against a complementary movement stop 54 on the cam 42 in the course of one revolution of the component 44. Since at the time when this occurs, the blockage of the rotation is removed by the overlap of the concave outer contour 43 with the edge 52, the contact of the movement stops 53, 54 initiates a rotation of the output-side gear wheel 37. This may cause the toothing of the drive-side gear wheel 34 and output-side gear wheel 37 to engage so that in the course of one revolution of the drive-side gear wheel 34, the output-side gear wheel 37 may also perform a revolution around the axis 31 until the gap 51 again faces the drive-side gear wheel 34.

When this happens, a stopper stop 55 of the cam 42 meets a complementary stopper stop 56 (each of which comprise respective stoppers) at a rear edge of the plate 49 in the direction of rotation and therefore may prevent the output-side gear wheel 37 from advancing, which may lead to a restoration of the frictional connection between the drive-side gear wheel 34 and the output-side gear wheel 37, until the concave outer contour 43 and the edge 52 overlap again far enough to block a rotation of the output-side gear wheel 37.

In order to enable uniform, low-friction movements when releasing and restoring the blockage, the stops 54, 55 of the cam 42 may be designed as rollers as shown in FIG. 3.

As long as the jaw clutch 38 is open as shown in FIG. 3, rotations of the drive-side gear wheel 34, during which the output-side gear wheel 37 remains at rest, alternate with those during which it also rotates, in a numerical ratio determined by the transmission ratio between the drive-side gear wheel 34 and the component 44 and the extension of its plates 49, 50 in the circumferential direction, but the second gearbox output 30 is not driven. Instead, it may be fixed in the orientation shown by a second jaw clutch 57, largely concealed behind a mounting flange 58 in FIG. 3. In this way, it may be ensured that the arm 28 is always in the position required for a correct gathering stroke movement as long as no filling stroke movement is being performed.

To initiate a filling stroke movement, it may be sufficient to move a selector fork 59 along the axis 31. By engaging in a groove 61 of a slider 60 in which the movable jaw 41 of the jaw clutch 38 and a movable jaw of the jaw clutch 57 are firmly connected, it may close the jaw clutch 38 and open the jaw clutch 57 in a single shifting movement.

In order to ensure that the second gearbox output 30 is correctly synchronized with the first gearbox output 24 during the filling stroke movement and that it resumes exactly the same position as before after the gathering stroke movement, the jaws of both clutches may be shaped in such a way that they only allow the jaws to engage with each other in one orientation of the clutch jaws relative to each other.

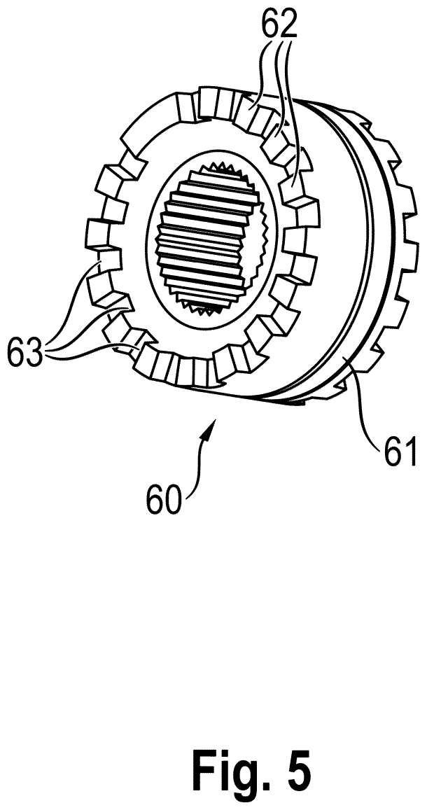

FIG. 5 illustrates an embodiment of the slider 60 designed for this purpose. The coupling jaw facing the observer may be the movable jaw 41 of the jaw clutch 38 as well as of the jaw clutch 57. A plurality of claws 62 of the same shape may be evenly distributed in the circumferential direction over one end face of the slider 60 and may in itself, in a manner customary in the art, be able to engage between the claws of the complementary jaw in as many different orientations as there are claws 62. However, in that one of the spaces 63 between the claws is filled and a claw on the complementary jaw is omitted, the number of orientations in which the clutch may be engaged is reduced to one.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Tractor
2 Piston press
3 Transfer case
4 Power take-off shaft
5 Pickup
6 Feed rake
7 Pressing channel
8 Ram
9 Knotting mechanism
10 Roller
11 Harvested material
12 Feed channel
13 Feed rake gearbox
14 Inlet end
15 Outlet end
16 Wall
17 Wall
18 Slot
19 Tip
20 Lever
21 First end
22 Second end
23 Pivot point
24 First gearbox output
25 Axis
26 Rod
27 Axis
28 Arm
29 Rod
30 Second gearbox output
31 Axis
32 Drive shaft
33 Planetary gear
34 Drive-side gear wheel
35 Intermediate gear
36 First output-side gear wheel
37 Second output-side gear wheel
38 Jaw clutch
39 Claw
40 Jaw
41 Jaw
42 Cam
43 Concave outer contour
44 Component
45 Ring
46 Stud axle
47 Pinion
48 Ring gear
49 Plate
50 Plate
51 Gap
52 Edge
53 Movement stop
54 Movement stop
55 Stopper
56 Stopper
57 Jaw clutch
58 Mounting flange
59 Selector fork
60 Slider
61 Groove
62 Claw
63 Claw intermediate space

1. A piston press comprising:
a press piston positioned movably in a pressing channel between end positions;
a feed channel;
a feed rake gearbox comprising a first gearbox output and a second gearbox output; and
a feed rake which, driven via the first gearbox output of the feed rake gearbox, is configured to move in the feed channel in order to operate in a plurality of operating modes including: in a first operating mode, execute a gathering stroke movement to compress harvested material in the feed channel; and in a second operating mode, a filling stroke movement which displaces the harvested material from the feed channel into the pressing channel;
wherein the feed rake gearbox is configured to control the second gearbox output in order to: drive only the first gearbox output in one of the plurality of operating modes; and to distribute drive power to both the first gearbox output and the second gearbox output in another of the plurality of operating modes.

2. The piston press of claim 1, wherein the one of the plurality of operating modes is the first operating mode and the another of the plurality of operating modes is the second operating mode.

3. The piston press of claim 2, wherein the feed rake gearbox includes a drive shaft; and
wherein, in the first operating mode, the second gearbox output is disengaged from the drive shaft of the feed rake gearbox.

4. The piston press of claim 2, wherein the feed rake gearbox comprises a pair of gears with a drive-side gear wheel and an output-side gear wheel which interact to drive the second gearbox output; and
wherein a toothing of the output-side gear wheel has a gap in a part of its circumference, through which teeth of the drive-side gear wheel pass in idling in at least a first phase of the first operating mode, in which the output-side gear wheel is in a rest position.

5. The piston press of claim 4, wherein the teeth of the drive-side gear wheel pass in idling without positive locking.

6. The piston press of claim 4, wherein a circular arc-shaped contour coupled to the drive-side gear wheel is configured to cooperate during the first phase with a complementarily shaped concave contour coupled to the output-side gear wheel to block rotation of the output-side gear wheel out of the rest position.

7. The piston press of claim 6, wherein the drive-side gear wheel and the output-side gear wheel are each rotationally coupled to a respective movement stop; and
wherein the output-side gear wheel is configured to rotate by abutting the respective movement stop from the rest position to a position in which the teeth of the drive-side gear wheel engage the teeth of the output-side gear wheel.

8. The piston press of claim 7, wherein the drive-side gear wheel and the output-side gear wheel are each coupled to a respective stopper; and
wherein the output-side gear wheel is configured to stop by abutting the respective stoppers against each other in a position in which the teeth of the drive-side gear wheel engage in the gap of the output-side gear wheel.

9. The piston press of claim 8, wherein the movement stop of the drive-side gear wheel is coupled to the drive-side gear wheel via a reduction gear.

10. The piston press of claim 9, wherein the reduction gear comprises a ring; and
wherein an inner surface of the ring positioned eccentrically to an axis of the drive-side gear wheel is in contact with an outer surface coupled to the drive-side gear wheel and centered about the axis.

11. The piston press of claim 10, wherein the inner surface comprises a ring gear and the outer surface comprises a pinion.

12. The piston press of claim 10, wherein the ring is configured to bear two plates, which are axially offset from each other and each extend radially over approximately half of its circumference.

13. The piston press of claim 4, further comprising a clutch by which the second gearbox output is configured to be disengaged from the output-side gear wheel in at least a second phase of the first operating mode.

14. The piston press of claim 13, wherein the clutch comprises a jaw clutch.

15. The piston press of claim 14, wherein the jaw clutch comprises at least two jaws; and
wherein the at least two jaws of the jaw clutch are engageable only in a single orientation relative to each other.

16. The piston press of claim 4, wherein the output-side gear wheel is positioned adjacent to the drive-side gear wheel and rotatable about an axis.

17. The piston press of claim 1, wherein the feed rake is configured to be driven by a lever which bears the feed rake at a first end, and which is coupled to the second gearbox output at a second end and to the first gearbox output at a central point between the first end and the second end.
